(19) United States
(12) Patent Application Publication
(10) Pub. No.: US 2024/0051021 A1
(43) Pub. Date: Feb. 15, 2024

(54) METHOD FOR IN SITU SYNTHESIZING ULTRAFINE AND HIGHLY LOADED AG NPS ON THE SURFACE OF TANNIN-COATED PHENOLIC RESIN MICROSPHERES

(71) Applicant: QILU UNIVERSITY OF TECHNOLOGY, Jinan, Shandong (CN)

(72) Inventors: Weikun JIANG, Jinan (CN); Shuo ZHANG, Jinan (CN); Yu LIU, Jinan (CN); Guolong LIU, Jinan (CN); Honglei CHEN, Jinan (CN)

(73) Assignee: QILU UNIVERSITY OF TECHNOLOGY, Jinan, Shandong (CN)

(21) Appl. No.: 18/030,376

(22) PCT Filed: Sep. 28, 2021
(86) PCT No.: PCT/CN2021/121373

§ 371 Date: Jul. 17, 2023

(30) Foreign Application Priority Data
Sep. 16, 2021 (CN) 202111086873.5

(51) Int. Cl. B22F 9/24; B22F 1/054; C08K 3/08; C08G 8/22; C08J 7/06

(52) U.S. Cl. CPC B22F 9/24; B22F 1/054; C08K 3/08; C08G 8/22; C08J 7/065; B82Y 30/00

(57) ABSTRACT

Provided a method for in situ synthesizing ultrafine and highly loaded Ag NPs on the surface of tannin-coated phenolic resin microspheres, the method comprises: (1) preparing phenolic resin microspheres by hydrothermal solvent method; (2) stirring a mixed phase of the phenolic resin microspheres and a tannin solution under a alkaline condition at room temperature to obtain tannin-coated phenolic resin microspheres; (3) adding the tannin-coated phenolic resin microspheres to a silver ammonia solution to obtain a composite that being loaded with Ag NPs on the surface of tannin-coated phenolic resin microspheres. Ag NPs in the composite are ultrafine and highly loaded. The raw materials of the method are low price, and the preparation process is extremely simple and environmentally friendly. In addition, the tannin coating technology is also suitable for other nanomaterials, such as SiO₂, TiO₂ and Fe₃O₄, etc., and has good application prospects and market potential.

### TECHNICAL FIELD

The present invention belongs to a field of biomass-based nanomaterials preparation technology, and specifically relates to a method for in situ synthesizing ultrafine and highly loaded Ag NPs on the surface of tannin-coated phenolic resin microspheres.

### BACKGROUND

Any discussion of the prior art throughout the specification should not be taken as an admission that such prior art is widely known or forms part of the common general knowledge in the art.

Silver nanoparticles (Ag NPs) are widely used in various fields due to good catalytic activity and strong antibacterial ability. Ag NPs with small size and high distribution density may have significantly improved catalytic activity and antibacterial ability. However, Ag NPs with small size and/or high distribution density are often challenging to prepare, and Ag NPs tend to aggregate due to their high specific surface energy, resulting their instability in solution and reducing their recyclability. To overcome these disadvantages, various materials have been investigated as supports/carriers for Ag NPs, such as graphene oxide (GO) sheets, porous materials, silica and polymer micro/nanospheres. Phenolic resins are often used commercially and they have been applied in various areas due to their low cost, excellent mechanical properties and heat resistance superior to those of most other polymer resin systems.

Currently, the phenolic resin micro/nanospheres for Ag NPs carriers has received extensive attention. It is well-known that the size and density (loading amount) of Ag NPs on the surface of phenolic resin micro/nanospheres are the two most important factors that influence their functions and applications. Current reports indicate that Ag NPs loaded on phenolic resin micro/nanospheres (a diameter is about 30 nm, and a loading amount is less than 20%, which is the size and distribution of most Ag NPs on phenolic resin micro/nanospheres) have shown high catalytic activity and stability. However, it remains a major challenge to obtain a high-density distribution of Ag NPs while loading smaller sizes, especially when the particle size of Ag NPs is controlled in a range of 5-20 nm.

Several methods for controlling the size and/or enhancing the loading amount of Ag NPs have been reported, such as laser-ablation method, electron irradiation method and chemical reduction method of capping agents. Among them, chemical method is the most common method. In this method, selecting the appropriate reducing agent and capping agents is key to designing smaller size and high-density distribution of Ag NPs. Tannin is a natural water-soluble plant polyphenol, and it is the second most abundant plant-based polyphenolic biopolymer on earth, which has been widely employed in various applications due to its valuable properties, including its green, anti-oxidative/reductive, antibacterial ability, biocompatible nature, and low-cost.

### SUMMARY

The present invention provides a method for in situ synthesizing ultrafine and highly loaded Ag NPs on the surface of tannin-coated phenolic resin microspheres, which solves the problems of large particle size and low loading amount of the loaded precious metal particles when loaded by means of prior art.

Specifically, the technical solution of the present invention is described below.

In a first aspect of the present invention, there is provided a method for in situ synthesizing ultrafine and highly loaded Ag NPs on the surface of tannin-coated phenolic resin microspheres, comprising:
coating phenolic resin microspheres with tannins to form tannin-coated phenolic resin microspheres; for example, the phenolic resin microspheres may be phenol resin (PR) microspheres, catechol-formaldehyde resin (CFR) microspheres or resorcinol-formaldehyde resin (RF) microspheres, etc., and the microspheres formed by tannin coating can be referred to as TA-PR, TA-CFR or TA-RF, respectively;
loading silver nanoparticles on the tannin-coated phenolic resin microspheres under a alkaline condition to obtain a composite that being loaded with silver nanoparticles on the surface of tannin-coated phenolic resin microspheres, such as TA-PR@Ag composite, TA-CFR@Ag composite, TA-RF@Ag composite, etc.

The method for in situ synthesizing Ag NPs on the surface of tannin-coated phenolic resin microspheres provided by the present invention is a simple method for reducing the size of Ag NPs and improving the loading amount of Ag NPs, which enables to achieve ultrafine and highly loaded Ag NPs on the surface of TA-CFR microsphere. Wherein under optimal conditions, a diameter of Ag NPs is ˜5 nm and a loading amount thereof exceeds 60%, which is the current reported Ag NPs with the smallest particle size and the highest loading amount of the Ag NPs on phenolic resin microspheres. For example, taking TA-CFR@Ag composite as an example, the TA-CFR microspheres as a carrier is based on the following rationale: (1) tannin coating on the surface of TA-CFR microspheres has multiple reductive phenolic-OH groups, which can be used as efficient reducing agents to achieve the in situ formation of Ag NPs. (2) Tannin biomolecules can be used as capping agents, which can control the growth degree of Ag crystalline structure during the synthesis process of Ag NPs. (3) The abundant phenolic-OH groups (e.g., five catechol and five galloyl moieties) on tannin biomolecules have a strong chelating ability to Ag NPs/Ag⁺, which enhancing the loading amount of Ag NPs. (4) Tannin coating improves surface charges of TA-CFR microspheres, which in turn improves the dispersion and stability of TA-CFR@Ag, so that it has better stability and reusability. As a green and environmentally friendly bio-based material, tannins have the characteristics of low price, green and sustainable. Tannin coating has little effect on the size of phenolic resin microspheres, but significantly improves the stability and durability of Ag NPs. The prepared TA-CFR@Ag has excellent catalytic reduction performance without the use of additional reducing agents. Besides, TA-CFR@Ag has good antibacterial properties and can efficiently inhibit the growth of microorganisms (e.g. E. coli and S. aureus) for a long time.

In a second aspect of the present invention, there is provided a composite that being loaded with silver nanoparticles on the surface of tannin-coated phenolic resin microspheres prepared by the above-mentioned method, such as TA-PR@Ag composite, TA-CFR@Ag composite, TA-RF@Ag composite; wherein a diameter of Ag NPs is as low as 5 nm, preferably in a range of 5-15 nm and a loading amount thereof exceeds 60%.

It is found that: compared with the method of combining tannins with microspheres such as Fe₃O₄ nanospheres, polylactic acid polymers, etc. to load silver, the binding steps of phenolic resin microspheres and tannins proposed by the present invention are simpler, without the addition of any surfactant; more importantly, with very simple operating steps, the loading effect of Ag NPs is better.

It is probably due to the fact that the surface of phenolic resin microspheres contains a large amount of aromatic ring structural units, which can be directly and closely adsorbed with tannins through π-π bonds, and then a large number of reducing groups on the surface of tannins can efficiently reduce Ag⁺ to form small-sized and uniformly distributed Ag NPs uniformly; more importantly, the surface of tannins contains a large number of chelating groups, which can better chelate and adsorb Ag NPs, which greatly improves the stability of application. However, the combination or adsorption steps of tannins with Fe₃O₄ nanospheres or polylactic acid polymers are cumbersome and costly. For example, additional steps such as adding surfactants or adding SiO₂ transition layers are required, and even then, Fe₃O₄ nanospheres and polylactic acid polymers are difficult to form a high density tannins like phenolic resin, which lead to their low loading amount of Ag NPs.

It is noteworthy that the adsorption of phenolic resin micro/nanospheres can be achieved by simple adsorption of tannins under alkaline conditions. Subsequently, the present invention uses this as a core structure to load Ag NPs, the loading amount of Ag NPs on the phenolic resin is exceeds 60%, and the size of Ag NPs is much smaller than that of Ag NPs on existing phenolic resin micro/nanospheres (at the level of about 30 nm in diameter), which is the current reported Ag NPs with the smallest particle size and the highest loading amount of the Ag NPs on phenolic resin micro/nano spheres.

In a third aspect of the present invention, there is provided an application of the above-mentioned composite that being loaded with silver nanoparticles on the surface of tannin-coated phenolic resin microspheres in the preparation of antimicrobial materials.

The beneficial effects of the present invention are as follow:
(1) Tannin is a natural water-soluble plant polyphenol, which is the second most abundant plant-based polyphenolic biopolymer on earth with low cost and wide source. It is used as a coating layer for phenolic resin micro/nanospheres to replace the commonly used surfactants or reducing agents to control the size of Ag NPs and improve the loading amount of Ag NPs, which can effectively saves costs. Compared with the existing reported nanomaterials using phenolic resin to load silver, the composite that being loaded with silver nanoparticles on the surface of tannin-coated phenolic resin microspheres (e.g. TA-CFR@Ag) of the present invention can be loaded with Ag NPs with smaller size and higher loading amount without changing the size of phenolic resin micro/nanospheres, and the nanomaterial has excellent water dispersibility, stability and reusability due to the fact that the surface contains a large number of phenolic hydroxyl structures. In addition, tannin coating technology is also suitable for other materials such as SiO₂, TiO₂ and Fe₃O₄, etc.
(2) The composite that being loaded with silver nanoparticles on the surface of tannin-coated phenolic resin microspheres (e.g. TA-CFR@ Ag) of the present invention has higher catalytic activity than existing reported Ag NPs materials, and has a wide application in the field of catalyst preparation. In addition to being loaded with precious metal Ag NPs, the tannin-coated phenolic resin microspheres (e.g. TA-CFR material) of the present invention can also be used as a carrier for nanomaterials such as precious metal gold, platinum and rhodium. In addition, this material can be used to prepare a variety of functional composite materials, giving materials more excellent properties, such as improving the mechanical strength and conductivity of composite materials, and giving materials antibacterial ability and anti-aging ability, etc., which has a very broad commercial prospect.
(3) The method of the present invention has the advantages of simple operation, low cost, and easy for large-scale production.

### BRIEF DESCRIPTION OF THE DRAWINGS

The accompanying drawings, which are incorporated in and constitute a part of the present invention, are included to provide a further understanding of the present invention, and the description of the exemplary embodiments and illustrations of the present invention are intended to explain the present invention and are not intended to limit the present invention.

FIG. 1 is a technical roadmap of the present invention with a specific example.

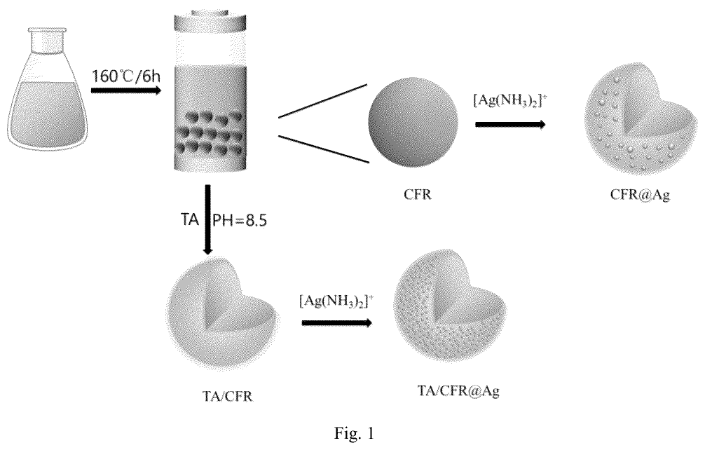

FIG. 2 is a scanning electron microscopy (SEM) images of the TA-CFR@Ag prepared in example 1 of the present invention.

FIG. 3 shows the loading amount of Ag NPs on the surface of TA-CFR@Ag composite prepared in example 1 of the present invention.

FIG. 4 shows a comparison of loading amount and size of Ag NPs on the surface of TA-CFR@Ag composite prepared in example 1 of the present invention and those in the prior arts.

### DETAILED DESCRIPTION

It should be noted that the following detailed descriptions are exemplary and are intended to provide further illustration of the present invention. Unless otherwise indicated, all technical and scientific terms used herein have the same meaning as commonly understood by one of ordinary skill in the art to which the present invention belongs.

The present invention provides a method for in situ synthesizing ultrafine and highly loaded Ag NPs on the surface of tannin-coated phenolic resin microspheres, the method comprises the following steps:
step 1: preparation of catechol-formaldehyde resin (CFR) microspheres.

The CFR microspheres were prepared as follows: catechol (100 mg, 0.9 mmol) and 25 wt % aqueous ammonia solutions (0.15 mL, 5 mmol) were mixed to an ethanol/water system (20 mL ethanol and 80 mL deionized water). The prepared mixture was sonicated for 5 minutes, and then 0.14 mL formaldehyde solution (3.8 mmol) was added into the above solution. Subsequently, the mixed solution was transferred to a sealed poly tetra fluoroethylene (PTFE) autoclave and stored at a constant temperature of 160° C. for 6 h. Finally, the CFR microspheres were washed with deionized water and ethanol several times and then collected and dried after centrifugation.
Step 2: preparation of tannin-coated catechol-formaldehyde resin (TA-CFR) microspheres. TA-CFR microspheres were synthesized as follows: 2 mg/mL of tannin solution was first prepared by adding 400 mg tannin to in the Tris-HCl buffer (200 mL, 100 mg, pH=8.5). Then, 100 mg dried CFR microspheres were immersed into the above solution. Keep magnetically stirring for 36 h and the TA-CFR composite as core nanostructures were synthesized. The TA-CFR microspheres were separated by centrifugation, cleaned by ultra-sonication and washed with deionized water and ethanol several times and then collected and dried.
Step 3: loading of Ag NPs (preparation of TA-CFR@Ag composites).

The TA-CFR@Ag composites were prepared as follows: silver ammonia solution was employed as the Ag precursor solution for the synthesis of TA-CFR@Ag composites. Silver ammonia solution was obtained by adding 5 wt % of aqueous ammonia solution to 50 mL of 16.9 mg/mL silver nitrate solution until all of the brown precipitate was dissolved. Next, the prepared TA-CFR microspheres (100 mg) were added to the above silver ammonia solution, and the mixed solution was stirred for 6 h at room temperature. The TA-CFR@Ag composites were washed with ethanol and deionized water several times and then collected and dried after centrifugation.

The technical solution of the present invention is further described in detail below in conjunction with specific examples. It should be noted that the specific examples are explanations of the present invention rather than limitations.

### Example 1

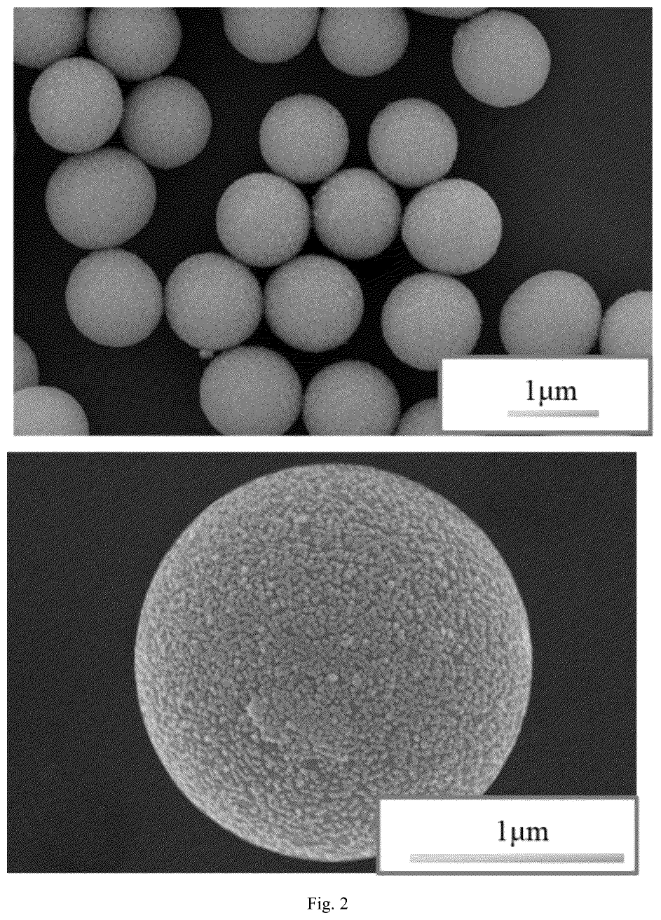

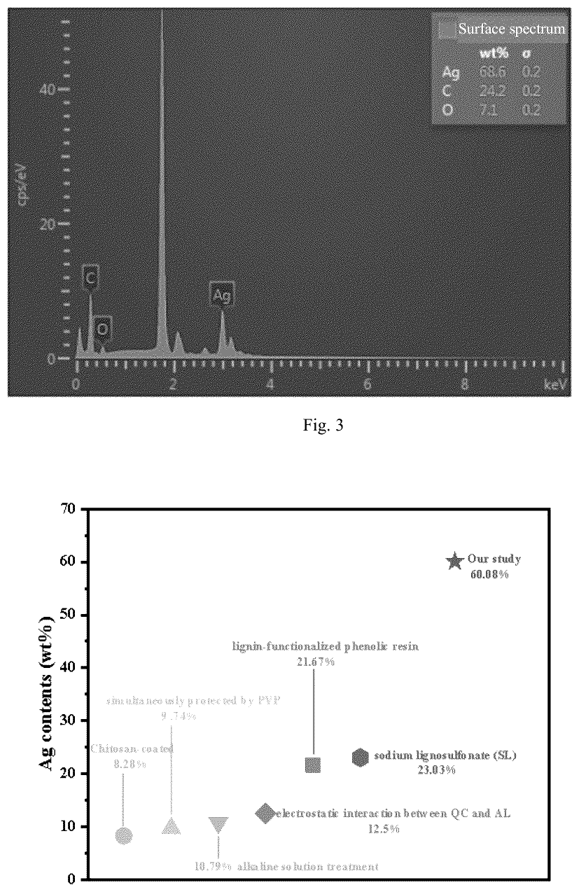

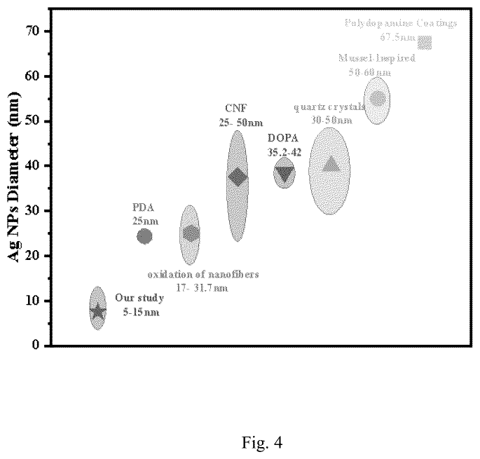

The CFR microspheres were prepared by modified Stöber method: catechol (100 mg, 0.9 mmol) and 25 wt % aqueous ammonia solutions (0.15 mL, 5 mmol) were mixed to an ethanol/water system (20 mL ethanol and 80 mL deionized water). The prepared mixture was sonicated for 5 minutes, and then 0.14 mL formaldehyde solution (3.8 mmol) was added into the above solution. Subsequently, the mixed solution was transferred to a sealed poly tetra fluoroethylene (PTFE) autoclave and stored at a constant temperature of 160° C. for 6 h. Finally, the CFR microspheres were washed with deionized water and ethanol several times and then collected and dried after centrifugation. TA-CFR microspheres were synthesized as follows: 2 mg/mL of tannin solution was prepared by adding 400 mg tannin to in the Tris-HCl buffer (200 mL, 100 mg, pH=8.5). Then, 100 mg dried CFR microspheres were immersed into the above solution. Keep magnetically stirring and reacting for 36 h and the TA-CFR composite as core nanostructures were synthesized. The TA-CFR microspheres were separated by centrifugation, cleaned by ultra-sonication and washed with deionized water and ethanol several times and then collected and dried. The TA-CFR@Ag composites were prepared as follows: silver ammonia solution (Tollens' reagent) was employed as the Ag precursor solution for the synthesis of TA-CFR@Ag composites. Silver ammonia solution was obtained by adding 5 wt % of aqueous ammonia solution to 50 mL of 16.9 mg/mL silver nitrate solution until all of the brown precipitate was dissolved. Next, the prepared TA-CFR microspheres (100 mg) were added to the above silver ammonia solution, and the mixed solution was stirred for 6 h at room temperature. After the in situ reduction, the TA-CFR@Ag composites were washed with ethanol and deionized water several times and then collected and dried after centrifugation. Scanning electron microscopy (SEM) images of the prepared TA-CFR@Ag were shown in FIG. 2. The loading amount of Ag NPs on the surface of TA-CFR@Ag composites was shown in FIG. 3. Comparison of Ag NPs loading amount and size in the example of the present invention and those in the prior arts were shown in FIG. 4.

### Example 2

The phenol resin (PR) microspheres were prepared by modified Stöber method: 200 mg of phenol, 280 mg of 37% formaldehyde solution and 17 mg of sodium hydroxide were mixed to an ethanol/water system (20 mL ethanol and 80 mL deionized water). The prepared mixture was heated at 65° C. for 1 h, and then heated at 90° C. for 30 minutes. Subsequently, the mixed solution was transferred to a sealed poly tetra fluoroethylene (PTFE) autoclave and heated at 120° C. for 12 h, and then naturally cooled to room temperature. Solid products were collected after centrifugation (10000 rpm, 5 minutes), and then washed with deionized water and ethanol three times. Finally, the thermoset PR microspheres were obtained by vacuum drying at 80° C. for 12 h. TA-PR microspheres were synthesized as follows: 2 mg/mL of tannin solution was prepared by adding 400 mg tannin into Tris-HCl buffer (200 mL, 100 mg, pH=8.5). Then, 100 mg dried PR microspheres were immersed into the above solution. Keep magnetically stirring and reacting for 36 h and the TA-PR composite as core nanostructures were synthesized. The TA-PR microspheres were separated by centrifugation, cleaned by ultra-sonication and washed with deionized water and ethanol several times and then collected and dried. The TA-PR@Ag composites were prepared as follows: silver ammonia solution (Tollens' reagent) was employed as the Ag precursor solution for the synthesis of TA-PR@Ag composites. Silver ammonia solution was obtained by adding 5 wt % of aqueous ammonia solution to 50 mL of 16.9 mg/mL silver nitrate solution until all of the brown precipitate was dissolved. Next, the prepared TA-PR microspheres (100 mg) were added to the above silver ammonia solution, and the mixed solution was stirred for 6 h at room temperature. After the in situ reduction, the TA-PR@Ag composites were washed with deionized water and ethanol several times and then collected and dried after centrifugation.

### Example 3

The resorcinol-formaldehyde resin (RF) microspheres were prepared by modified Stöber method: aqueous ammonia solution (0.1 mL, 25 wt %) were mixed with a solution containing absolute ethanol (8 mL) and deionized water (20 mL). The prepared mixture was stirred for more than 1 h, and then 200 mg of resorcinol was added into the mixture and stirred continuously for 30 minutes, and then 0.28 mL formaldehyde solution was added into the above solution and stirred at 30° C. for 24 h. Subsequently, the mixed solution was transferred to a sealed poly tetra fluoroethylene (PTFE) autoclave and heated statically at 100° C. for 24 h, and then washed with deionized water and ethanol three times. Finally, the thermoset RF microspheres were obtained by vacuum drying at 100° C. for 12 h. TA-RF microspheres were synthesized as follows: 2 mg/mL of tannin solution was prepared by adding 400 mg tannin into Tris-HCl buffer (200 mL, 100 mg, pH=8.5). Then, 100 mg dried RF microspheres were immersed into the above solution. Keep magnetically stirring and reacting for 36 h and the TA-RF composite as core nanostructures were synthesized. The TA-RF microspheres were separated by centrifugation, cleaned by ultra-sonication and washed with deionized water and ethanol several times and then collected and dried. The TA-RF@Ag composites were prepared as follows: silver ammonia solution (Tollens' reagent) was employed as the Ag precursor solution for the synthesis of TA-RF@Ag composites. Silver ammonia solution was obtained by adding 5 wt % of aqueous ammonia solution to 50 mL of 16.9 mg/mL silver nitrate solution until all of the brown precipitate was dissolved. Next, the prepared TA-RF microspheres (100 mg) were added to the above silver ammonia solution, and the mixed solution was stirred for 6 h at room temperature. After the in situ reduction, the TA-RF@Ag composites were washed with deionized water and ethanol several times and then collected and dried after centrifugation.

Finally, it should be noted that, the above description is only a preferred embodiment of the present invention and is not intended to limit the present invention. Although the present invention has been described in detail with reference to the foregoing embodiments, it is still possible for those skilled in the art to modify the technical solution described in the foregoing embodiments, or to replace some of them equivalently. Any modifications, equivalents, improvements, etc. made within the spirit and principles of the present invention shall be covered by the protection of the present invention rights.

What is claimed is:

1. A method for in situ synthesizing ultrafine and highly loaded Ag NPs on the surface of tannin-coated phenolic resin microspheres, comprising:
coating phenolic resin microspheres with tannins to form tannin-coated phenolic resin microspheres;
loading silver nanoparticles on the tannin-coated phenolic resin microspheres under a alkaline condition to obtain a composite that being loaded with silver nanoparticles on the surface of tannin-coated phenolic resin microspheres.

2. The method according to claim 1, wherein said coating phenolic resin microspheres with tannins comprises: immersing phenolic resin microspheres in a tannins solution, mechanically stirring for 36-42 h, performing solid-liquid separation, cleaning and drying to obtain the TA-CFR microspheres.

3. The method according to claim 2, wherein a concentration of the tannins solution is 1-5 mg/mL, preferably, the concentration is 2 mg/mL.

4. The method according to claim 1, wherein a method for loading Ag NPs, comprising, adding the tannin-coated phenolic resin microspheres to a silver ammonia solution, mechanically stirring for 4-8 h, washing, performing solid-liquid separation and drying to obtain the composite that being loaded with silver nanoparticles on the surface of tannin-coated phenolic resin microspheres.

5. The method according to claim 4, wherein a method for preparing the silver ammonia solution, comprising: adding of an aqueous ammonia solution to a silver nitrate solution until all of brown precipitate generated was dissolved.

6. The method according to claim 1, wherein the phenolic resin microspheres are prepared by a modified Stöber method.

7. The method according to claim 1, wherein a method for preparing the phenolic resin microspheres, comprising adding one of catechol, resorcinol and phenol together with an aqueous ammonia solution into a mixed solution of ethanol and water, sonicating the prepared mixture, adding a formaldehyde solution to the prepared mixture, reacting at 160-180° C. for 6 h under a closed condition, washing, performing solid-liquid separation and drying to obtain the phenolic resin microspheres.

8. A composite that being loaded with silver nanoparticles on the surface of tannin-coated phenolic resin microspheres prepared by a method according to any one of claims 1-7.

9. The composite according to claim 8, wherein a diameter of silver nanoparticles loaded on the surface of tannin-coated phenolic resin microspheres is as low as ˜5 nm and a loading amount exceeds 60%.

10. An application of a composite according to claim 8 or 9 in the preparation of antimicrobial materials.
